(19) United States
(12) Patent Application Publication
(10) Pub. No.: US 2011/0305935 A1
(43) Pub. Date: Dec. 15, 2011

(54) Battery pack

(76) Inventor: Ji-Hyoung Yoon, Yongin-si (KR)

(21) Appl. No.: 12/929,281

(22) Filed: Jan. 12, 2011

(30) Foreign Application Priority Data
Jun. 10, 2010 (KR) 10-2010-0055107

(51) Int. Cl. H01M 10/50

(52) U.S. Cl. 429/120

(57) ABSTRACT

A battery pack includes a plurality of battery cells including a plurality of terminals, and a cooling member including a plurality of contact portions contacting the terminals.

### BACKGROUND

1. Field of the Invention

Embodiments relate to a battery pack.

2. Description of the Related Art

With the widespread use of gasoline vehicles, air pollution has increased due to harmful components such as combustion-derived nitrogen oxides, and carbon monoxide or hydrocarbons resulting from incomplete combustion, in exhaust gas of the vehicles. Also, due to fossil fuel depletion, development of next-generation energy sources and development of electric vehicles are frequently discussed.

### SUMMARY

Example embodiments are directed to a battery pack, including a plurality of battery cells including a plurality of terminals, and a cooling member including a plurality of contact portions contacting the terminals.

The contact portions may be thermally conductive.

The plurality of contact portions may be electrically isolated from the terminals.

The contact portions may include respective accommodation holes in an inner portion thereof, the accommodation holes being configured to accommodate the terminals, and the terminals may be inserted into the respective accommodation holes.

The cooling member may include a thermally conductive material.

The contact portions may be at a first surface of the cooling member in positions corresponding to the terminals, and a second surface of the cooling member opposite to the first surface may be flat.

The cooling member may be formed of a metal, an external surface of the metal being surrounded by an oxide layer at the contact portions.

The contact portions may be at a first surface of the cooling member in positions corresponding to the terminals, and a plurality of fluid channels may be disposed at a second surface of the cooling member opposite to the first surface.

The fluid channels may correspond to the contact portions.

The fluid channels may have a surface exposed to an ambient atmosphere.

The cooling member may be formed of a metal, an external surface of the metal being surrounded by an oxide layer at the contact portions.

The cooling member may include a case portion formed of a thermally conductive material, the case portion including a heat absorption portion, and a plurality of contact portions on a surface of the case portion in positions corresponding to the terminals.

The heat absorption portion may be hollow such that air flows through the heat absorption portion. The battery pack may further include an inflow pipe, the inflow pipe being disposed at a first end of the heat absorption portion so as to allow the air from outside the heat absorption portion to flow through the heat absorption portion; and an outflow pipe, the outflow pipe being disposed at a second end of the heat absorption portion so as to discharge the air of the heat absorption portion to the outside.

The heat absorption portion may filled with a heat-absorbing material that absorbs heat.

The heat-absorbing material may include silicone oil.

The heat-absorbing material may include a phase change material.

A cross-section of the contact portions farther from the terminals may be larger than a cross-section of the contact portions nearer to the terminals.

At least a portion of an upper surface and a lateral surface of the contact portions may be exposed to the heat absorption portion.

The case portion and the contact portions may be formed as a single unit.

The case portion and the contact portions may include a thermally conductive plastic.

### BRIEF DESCRIPTION OF THE DRAWINGS

The above and other features and advantages will become more apparent to those of skill in the art by describing in detail example embodiments with reference to the attached drawings, in which:

FIG. 1 illustrates a perspective view of a battery pack according to a first embodiment;

FIG. 2 illustrates a perspective view of main components of the battery pack of FIG. 1;

FIG. 3 illustrates a bottom perspective view of a cooling member of FIG. 1;

FIG. 4 illustrates a cross-sectional view of a cooling member cut along a line IV-IV of FIG. 2;

FIG. 5 illustrates a perspective view of a battery pack according to a second embodiment;

FIG. 6 illustrates a cross-sectional view of a cooling member cut along a line VI-VI of FIG. 5;

FIG. 7 illustrates a perspective view of a battery pack according to a third embodiment;

FIG. 8 illustrates a cross-sectional view of a cooling member cut along a line VIII-VIII of FIG. 7;

FIG. 9 illustrates a cross-sectional view of a cooling member according to another embodiment;

FIG. 10 illustrates a cross-sectional view of a cooling member according to another embodiment; and

FIG. 11 illustrates a cross-sectional view of a cooling member according to a fourth embodiment.

### DETAILED DESCRIPTION OF THE INVENTION

Korean Patent Application No. 10-2010-0055107, filed on Jun. 10, 2010, in the Korean Intellectual Property Office, and entitled: “Battery Pack,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. Like reference numerals refer to like elements throughout.

The terminology used herein is for the purpose of describing particular embodiments only and is not intended to be limiting of example embodiments. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated elements, steps, operations, and/or components, but do not preclude the presence or addition of one or more other elements, steps, operations, components, and/or groups thereof. In the present description, terms such as “first,” “second,” etc., are used to describe various elements. However, the elements should not be defined by these terms. The terms are used only for distinguishing one element from another element.

It will be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present.

In this specification, terminals refer to elements included in the battery cells 100, including both a positive electrode terminal 101 and a negative electrode terminal 102.

### First Embodiment

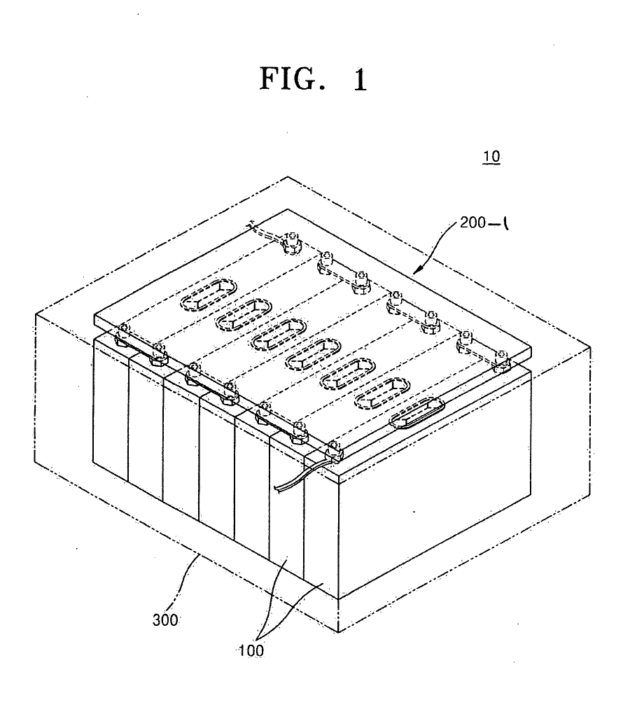

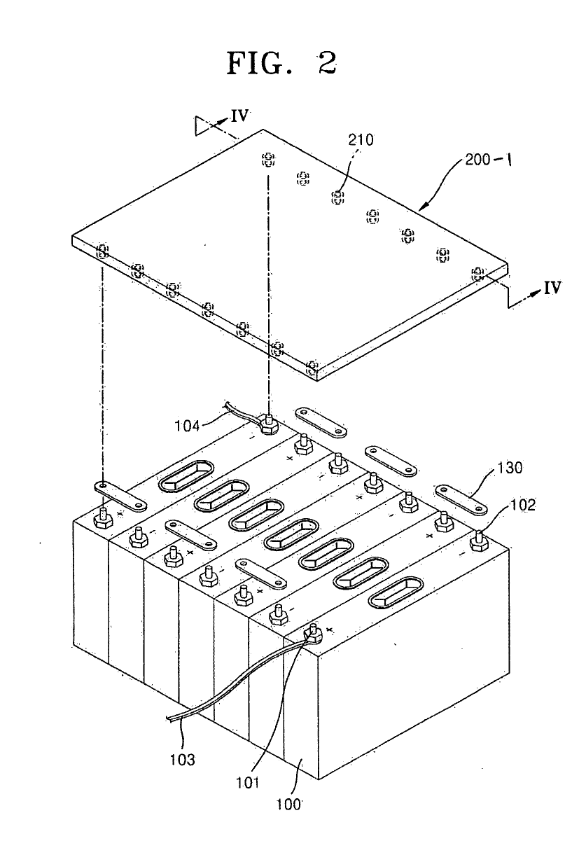

FIG. 1 illustrates a perspective view of a battery pack 10 according to a first embodiment, and FIG. 2 illustrates a perspective view of the battery pack 10 of FIG. 1 from which a housing 300 is omitted. In the example shown in FIGS. 1 and 2, the battery pack 10 includes a plurality of battery cells 100, a cooling member 200-1, and a housing 300.

The plurality of battery cells 100 may be arranged parallel to one another in a row. The battery cells 100 may be accommodated in the housing 300.

A positive electrode terminal 101 and a negative electrode terminal 102 may be formed for each of the battery cells 100 in the form of protrusions. For example, the positive electrode terminals 101 and the negative electrode terminals 102 may be disposed on an upper surface of the battery cells 100. In the example shown in FIGS. 1 and 2, the positive electrode terminals 101 and the negative electrode terminals 102 are shown as being alternately disposed for each battery cell 100. In another implementation, the positive electrode terminals 101 of the battery cells 100 may be disposed on the same sides, and the negative electrode terminals 102 may be disposed on the opposite sides to the positive electrode terminals 101.

In the example shown in FIGS. 1 and 2, a positive electrode lead line 103 is coupled to the positive electrode terminal 101 of the outermost battery cell 100, and a negative electrode lead line 104 is coupled to the negative electrode terminal 102 of the outermost battery cell 100 on the opposite end. The positive electrode lead line 103 and the negative electrode lead line 104 may be connected to a load such as a driving motor (not shown) of an electric vehicle to supply electricity to the load. Meanwhile, the positive electrode terminals 101 and negative electrode terminals 102 of the battery cells 100 not coupled to the positive electrode lead line 103 and the negative electrode lead line 104 may be electrically connected to each other in pairs via respective conductive plates 130.

In the example shown in FIGS. 1 and 2, the conductive plates 130 electrically connect the positive electrode terminals 101 and negative electrode terminals 102 of each of the battery cells 100 in pairs. The conductive plate 130 may be formed of an electrically conductive material. Thus, electricity may be conducted between the battery cells 100 via the conductive plate 130. Depending on the connection of the conductive plate 130, the battery cells 100 may be connected in series or in parallel. In the example shown in FIGS. 1 and 2, the conductive plate 130 serially connects the positive and negative electrode terminals 101 and 102 of the nearest battery cells 100. In another implementation, two conductive plates 130 may be formed, and one conductive plate 130 may connect the positive electrode terminals 101 of each battery cell 100 to one another, and the other conductive plate 130 may connect negative electrode terminals 102 of each battery cell 100 to one another, to thereby form a parallel connection.

The cooling member 200-1 may be configured to dissipate heat generated in the positive electrode terminals 101 and/or negative electrode terminals 102 of the battery cells 100. When charging or discharging the battery cells 100, heat may be generated in the battery cells 100. Heat may be conducted via the positive and negative electrode terminals 101 and 102. Also, the generated heat may be transferred to other battery cells 100 through the conductive plates 130 connecting the positive and negative electrode terminals 101 and 102. Heat generation and heat transfer may lead to an overall performance decrease of the battery pack 10. Thus, the cooling member 200-1 may include a plurality of contact portions 210 to dissipate the heat generated in the positive and negative electrode terminals 101 and 102.

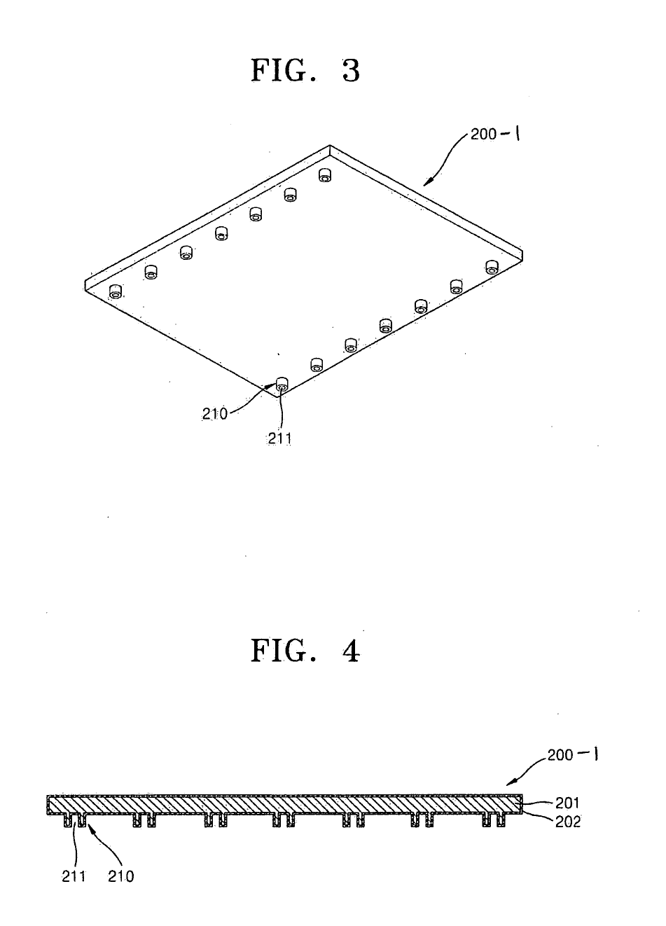

In the example shown in FIGS. 1 and 2, the plurality of contact portions 210 is arranged on a surface of the cooling member 200-1 corresponding to the positive and negative electrode terminals 101 and 102. The cooling member 200-1 contacts the positive and negative electrode terminals 101 and 102 via the contact portions 210, such that the heat generated in the positive and negative electrode terminals 101 and 102 of the battery cells 100 may be transferred to the cooling member 200-1 through the contact portions 210. This will be described in more detail below with reference to FIGS. 3 and 4.

FIG. 3 illustrates a perspective view of a lower surface of the cooling member 200-1 of FIG. 1, and FIG. 4 illustrates a cross-sectional view of the cooling member 200-1 cut along a line IV-IV of FIG. 2.

In the example shown in FIGS. 3 and 4, a plurality of accommodation holes 211 accommodating the positive and negative electrode terminals 101 and 102 are formed in the contact portions 210 disposed at the surface, for example, on a lower surface, of the cooling member 200-1. The positive electrode terminal 101 and the negative electrode terminal 102 may be inserted into the contact portions 210 via the accommodation holes 211. A size of the accommodation holes 211 may be the same as the positive and negative electrode terminals 101 and 102, in which case an external surface of the positive and negative electrode terminals 101 and 102 may directly contact an inner surface of the corresponding contact portion 210. When the positive and negative electrode terminals 101 and 102 directly contact the contact portions 210, heat generated in the positive and negative electrode terminals 101 and 102 may be efficiently transferred to the cooling member 200-1.

In the current example, the positive and negative electrode terminals 101 and 102, and the accommodation holes 211, have a cylindrical shape. In another implementation, the positive and negative electrode terminals 101 and 102, and the accommodation hole 211, may be in the form of polygonal pillars. The positive and negative electrode terminals 101 and 102 and the accommodation holes 211 may have a form that increases a contact surface of the contact portions 210 such that heat of the positive and negative electrode terminals 101 and 102 is efficiently transferred to the cooling member 200-1.

The cooling member 200-1 may be formed of a thermally conductive material having a high thermal conductivity. For example, the cooling member 200-1 may be formed of a metal such as aluminum or silver, or an insulation material such as thermally conductive plastic. When the cooling member 200-1 is formed of an electrically conductive material such as metal, the contact portions 210 are preferably electrically isolated from the positive and negative electrode terminals 101 and 102 in order to prevent current flowing through the positive and negative electrode terminals 101 and 102 of the battery cell 100 from flowing through the cooling member 200-1. For example, referring to FIG. 4, an insulation layer such as an oxide layer 202 may be included in the contact portions 210.

For example, in the case that the cooling member 200-1 is formed of a metal 201 such as aluminum, an aluminum oxide layer 202 may be used as an insulation layer. A thickness of the aluminum oxide layer 202 may be determined according to design of the battery pack 10. For example, when a thickness of the aluminum oxide layer 202 is about 20 μm or less, the aluminum oxide layer 202 may be insulated from a voltage of up to about 50 V; when the aluminum oxide layer 202 has a thickness of about 20 to about 50 μm, the aluminum oxide layer 202 may be insulated from a voltage up to about 3,000 V. In an implementation, the oxide layer 202 may be formed on the entire surface of the cooling member 200-1, as illustrated in FIG. 4. In another implementation, the oxide layer 202 may only be formed at the contact portions 210.

The cooling member 200-1 may be formed of a material having a high thermal conductivity and a large heat capacity. By using the large heat capacity material to form the cooling member 200-1, more heat may be absorbed in the cooling member 200-1 so as to increase the cooling efficiency of the positive and negative electrode terminals 101 and 102.

An upper surface of the cooling member 200-1 may be in the form of a flat plane. Heat transferred through the contact portions 210 may be radiated through the upper surface of the cooling member 200-1.

Not only the heat generated during charging or discharging of the battery cells 100, but also a large amount of heat that may be abnormally generated in the positive and negative electrode terminals 101 and 102 of one of the battery cells 100, may be dissipated through the cooling member 200-1. Thus, the heat in the positive and negative electrode terminals 101 and 102 may be prevented from being transferred to other battery cells 100, which may help prevent a decrease in the performance of the battery pack 10.

In the example shown in FIG. 1, both the battery cells 100 and the cooling member 200-1 are included in the housing 300. In another implementation, the housing 300 may be omitted. In another implementation, the upper surface of the cooling member 200-1 may be exposed out of the housing 300. Heat generated in the positive and negative electrode terminals 101 and 102 may be radiated through the upper surface of the cooling member 200-1 that is exposed out of the housing 300.

### Second Embodiment

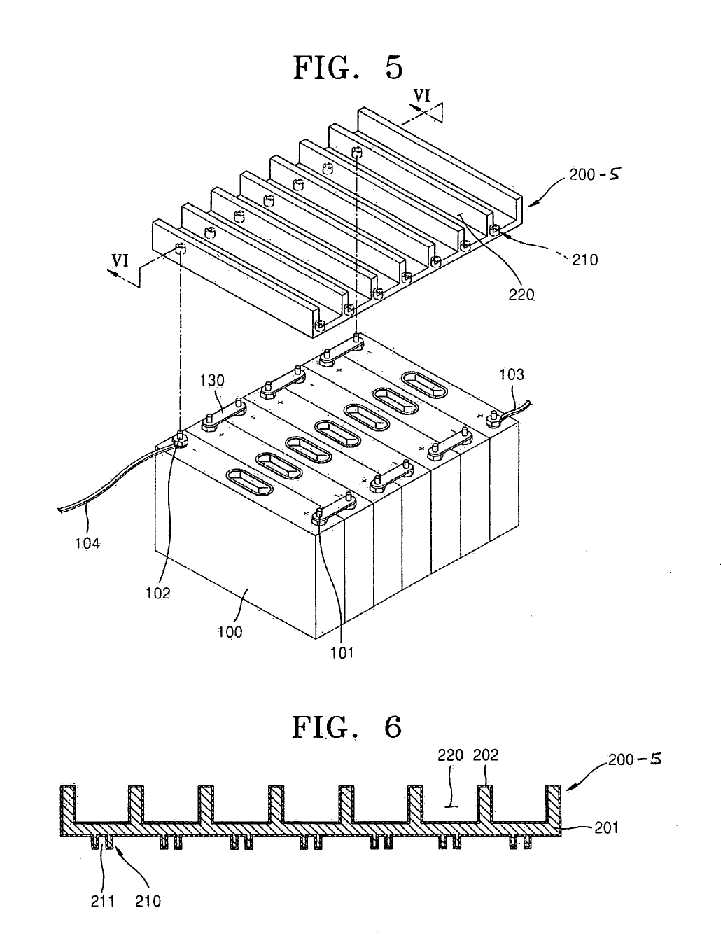

FIG. 5 illustrates a perspective view of a battery pack 10 according to a second embodiment. FIG. 6 illustrates a cross-sectional view of a cooling member 200-5 cut along a line VI-VI of FIG. 5. In the example shown in FIGS. 5 and 6, positive electrode terminals 101 and negative electrode terminals 102 of each of the battery cells 100 are electrically connected to each other in pairs via conductive plates 130, and a plurality of contact portions 210 is disposed on a lower surface of the cooling member 200-5 corresponding to the positive and negative electrode terminals 101 and 102. Also, accommodation holes 211 are respectively formed in the contact portions 210.

At least one fluid channel 220 may be formed on an upper surface of the cooling member 200-5. For example, a plurality of fluid channels 220 may be formed on the upper surface of the cooling member 200-5 so as to increase a surface area in contact with a cooling medium, e.g., ambient air. The cooling member 200-5 may be formed of a material having a high thermal conductivity, preferably, a material having a high thermal conductivity and a large heat capacity. The cooling efficiency of the battery pack 10 may be increased by forming the plurality of fluid channels 220 to use air, which has a large heat capacity and active air convection, and by forming the cooling member 200-5 of a material having a high thermal conductivity and a large heat capacity at the same time.

In the case that the cooling member 200-5 is formed of a conductive material such as metal through which current can flow, the contact portion 210 is preferably electrically isolated from the positive and negative electrode terminals 101 and 102 in order to prevent the current flowing through the conductive plate 130 from flowing to the cooling member 200-5. For example, the contact portion 210 may have an insulation layer such as the oxide layer 202.

In an implementation, the oxide layer 202 may be formed on the entire surface of the cooling member 200-5, as illustrated in FIG. 6. For example, when the cooling member 200-5 is formed of a metal 201 such as aluminum, an aluminum oxide layer 202 may be used as an insulation layer.

The fluid channels 220 formed on the upper surface of the cooling member 200-5 may be disposed at portions corresponding to the contact portions 210. For example, the contact portions 210 may be disposed under the fluid channels 220. The fluid channels 220 may be formed in positions corresponding to the contact portions 210. Thus, heat transferred through the contact portions 210 may be efficiently dissipated by the air flowing through the fluid channels 220.

The cooling member 200-5 may be mounted inside the housing 300 or protruded out of the housing 300 so as to be exposed to the atmosphere. In the case that the cooling member 200-5 is included in the housing 300, a fan (not shown) may be provided at a surface of the housing 300 corresponding to the fluid channels 220 to thereby facilitate the flow of the air.

### Third Embodiment

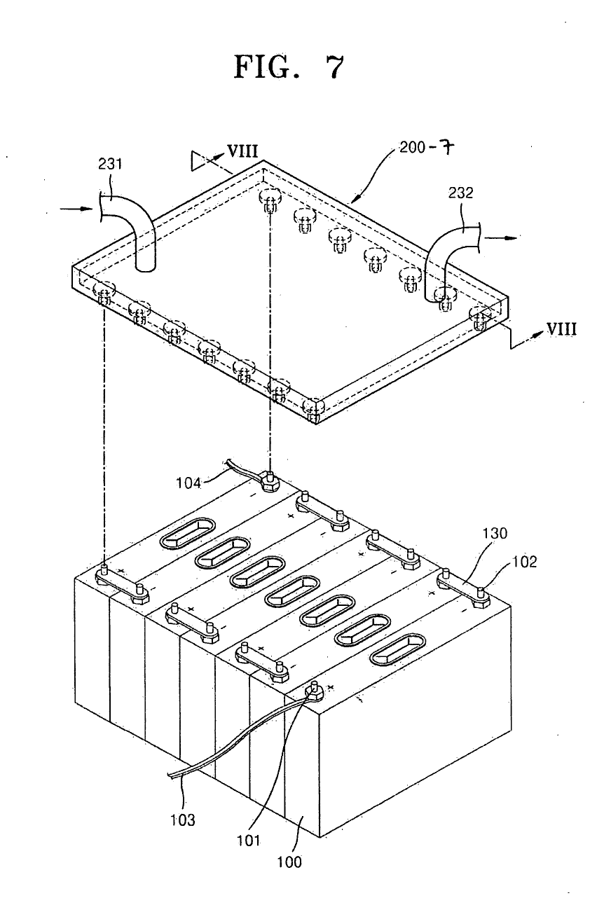

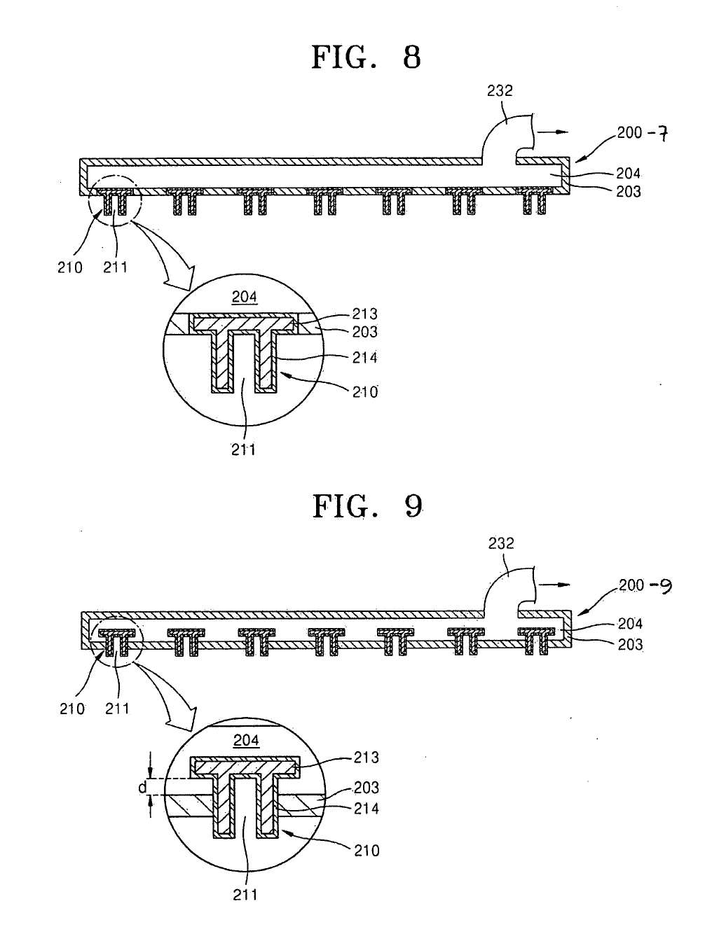

FIG. 7 illustrates a perspective view of a battery pack 10 according to a third embodiment; FIG. 8 illustrates a cross-sectional view of a cooling member 200-7 cut along a line VIII-VIII of FIG. 7. In the example shown in FIGS. 6 and 7, positive electrode terminals 101 and negative electrode terminals 102 of each of the battery cells 100 are electrically connected to each other in pairs via conductive plates 130, and a plurality of contact portions 210 are disposed on a lower surface of the cooling member 200-7 corresponding to the positive and negative electrode terminals 101 and 102. Also, accommodation holes 211 are respectively formed in the contact portions 210.

A path through which air flows may not be directly exposed. For example, the cooling member 200-7 may include a case portion 203 including a heat absorption portion 204 and the contact portions 210. The heat absorption portion 204 may be hollow such that a cooling medium, e.g., air, can flow therethrough. To provide for air flow, an inflow pipe 231 that enables the air to flow into the heat absorption portion 204 may be provided at a first end of the heat absorption portion 204, and an outflow pipe 232 for discharging the air may be provide at a second end of the heat absorption portion 204.

In the example shown in FIGS. 6 and 7, the heat absorption portion 204 has a rectangular hollow form. In another implementation, the heat absorption portion 204 may have a meandering pipe configuration within, to increase the distance and time that the air flows.

The case portion 203 having the heat absorption portion 204 may be formed of a suitable material. In the case that the case portion 203 is formed of a material having a high thermal conductivity and a large heat capacity, heat generated in the positive and negative electrode terminals 101 and 102 may be dissipated more efficiently. For example, the case portion 203 may be formed of a thermally conductive plastic.

Here, the contact portion 210 contacting the positive and negative electrode terminals 101 and 102 may be formed of a metal 213 having a high thermal conductivity, which can efficiently receive heat generated in the positive and negative electrode terminals 101 and 102. In the case that the case portion 203 is electrically insulating, the contact portions 210 formed of a metal 213 may be used as is. However, in the case that the case portion is electrically conductive and the contact portions 210 are formed of the metal 213, current flowing through the positive and negative electrode terminals 101 and 102 may also flow through the contact portions 210 due to the electrical conductivity of the metal 213. To prevent this, an insulation layer such as an oxide layer 214 may be formed on an external surface of the metal 213.

As illustrated in FIG. 8, a cross-section of the contact portion 210 farther from the positive and negative electrode terminals 101 and 102 may be greater than a cross-section of the contact portion 210 nearer to the positive and negative electrode terminals 101 and 102. By providing a large upper surface, a surface area of the contact portion 210 contacting the air that flows through the heat absorption portion 204 may be increased by the size of the upper surface. Accordingly, the cooling efficiency with respect to the heat generated in the positive and negative electrode terminals 101 and 102 may be increased. In another implementation, the contact portion 210 may have a surface area that gradually increases in an upward direction of the positive and negative electrode terminals 101 and 102 (not shown).

FIG. 9 illustrates a vertical cross-sectional view of the cooling member 200-9 according to another embodiment. In the cooling member 200-9 of the current embodiment, the contact portions 210 are moved upward. As the contact portions 210 are moved a distance d (see the inset in FIG. 9), at least a portion of an upper surface and a lateral surface of the contact portions 210 may be exposed to the air. The surface area exposed to the air may be increased by moving the contact portions 210 upward. Also, the cooling efficiency with respect to the heat generated in the positive and negative electrode terminals 101 and 102 may be increased by forming the contact portions 210 of a material having a high thermal conductivity.

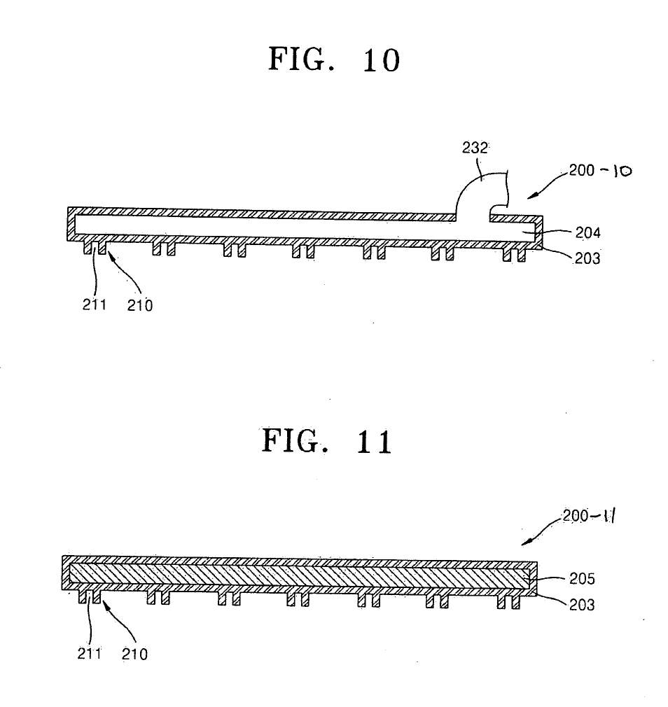

FIG. 10 illustrates a vertical cross-sectional view of the cooling member 200-10 according to another embodiment. When the case portion 203 is formed of a plastic which is a thermally conductive material, the contact portions 210 may be formed as a single unit with the case portion 203. For example, the contact portions 210 may be integrally formed with the case portion 203 using, e.g., a casting or molding operation.

To provide for air flow, the inflow pipe 231 that enables the air to flow into the heat absorption portion 204 may be provided at a first end of the heat absorption portion 204, and the outflow pipe 232 for discharging the air may be provide at a second end of the heat absorption portion 204.

In the case that the thermally conductive plastic is an electrically insulating material, current flowing through the positive and negative electrode terminals 101 and 102 may be prevented from flowing to the cooling member 200-10. Accordingly, an additional insulating feature, e.g., the oxide layer described above or the like, may be omitted. Also, as the contact portions 210 may be formed as a single unit with the case portion 203, the cost and time for manufacturing the cooling member 200-10 may be reduced.

### Fourth Embodiment

FIG. 11 illustrates a vertical cross-sectional view of a cooling member 200-11 according to a fourth embodiment. In the example shown in FIG. 11, a plurality of contact portions 210 is disposed on a lower surface of the cooling member 200-11 corresponding to the positive and negative electrode terminals 101 and 102. Also, accommodation holes 211 are respectively formed in the contact portions 210.

A heat-absorbing material for dissipating heat generated in the positive and negative electrode terminals 101 and 102 may be included in the cooling member 200-11. For example, the cooling member 200-11 may include a case portion 203 including a heat absorption portion 205 and the contact portions 210. As illustrated in FIG. 11, the contact portions 210 may be formed as a single unit with the case portion 203. In this case, the contact portions 210 and the case portion 203 may be formed of a material having a high thermal conductivity, so that heat generated in the positive and negative electrode terminals 101 and 102 may be efficiently transferred. For example, the contact portions 210 and the case portion 203 may be formed of a thermally conductive plastic.

In the case that the contact portions 210 and the case portion 203 are formed of a thermally conductive plastic, an additional insulation layer may be omitted from the contact portions 210 where the thermally conductive plastic is an electric insulator. Also, as the contact portions 210 may be formed as a single unit with the case portion 203, the cost and time for manufacturing the cooling member 200-11 may be reduced.

The heat absorption portion 205 may be filled with a heat-absorbing material for absorbing heat generated in the positive and negative electrode terminals 101 and 102. The heat-absorbing material may absorb heat of the positive and negative electrode terminals 101 and 102, which is transferred through the contact portions 210, and may be formed of a material having a high thermal conductivity and a large heat capacity. For example, the heat-absorbing material may be silicone oil, glycerin, etc. In another implementation, the heat-absorbing material may be a phase change material (PCM). For example, the PCM may be n-paraffin, PEG (polyethylene glycol), Na₂SO₄.10H₂O, Na₂HPO₄.12H₂O, Zn(NO₃)₂.6H₂O, Na₂S₃O₃.5H₂O, etc.

The contact portions 210 may also be moved upward, like in the embodiment described above with reference to FIG. 9, such that at least a portion of an upper surface and a lateral surface of the contact portions 210 is exposed to the heat absorption portion 205.

As described above, embodiments are directed to a battery pack configured to dissipate heat from a terminal or terminals of a battery cell through a thermally conductive plate, so as to reduce or prevent the heat from transferring to another battery cell. In regard to the commercialization of electric vehicles, the distance covered by electric vehicles may be determined by battery performance, and batteries that are not capable of supplying sufficient electric energy may not secure sufficient mileage. When a vehicle uses gasoline, diesel, or gas as the energy source, it can be quickly fueled at a gas station or a liquefied petroleum gas (LPG) station. For electric vehicles, even when charging stations are provided, it may take a relatively long time to charge the vehicle. Also, heat generated from the battery may be problematic. Electric vehicles battery performance improvements may enable further commercialization of such vehicles. According to embodiments described herein, a cooling member including a contact portion contacting a terminal of a battery cell may be provided to efficiently dissipate heat from the terminals of each of the battery cells. In addition, if a large amount of heat is abnormally generated in a terminal of one of the battery cells, the heat may be prevented from transferring to another battery cell to maintain the overall performance of the battery pack. Thus, performance and reliability of the battery pack may be enhanced. Such enhanced performance may be significant in advancing utility of the battery pack, e.g., by enabling improvements in electric vehicles such as plug-in electrics, hybrids, etc.

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope of the present invention as set forth in the following claims.

What is claimed is:

1. A battery pack, comprising:
a plurality of battery cells including a plurality of terminals; and
a cooling member including a plurality of contact portions contacting the terminals.

2. The battery pack as claimed in claim 1, wherein the contact portions are thermally conductive.

3. The battery pack as claimed in claim 1, wherein the plurality of contact portions is electrically isolated from the terminals.

4. The battery pack as claimed in claim 1, wherein:
the contact portions include respective accommodation holes in an inner portion thereof, the accommodation holes being configured to accommodate the terminals, and
the terminals are inserted into the respective accommodation holes.

5. The battery pack as claimed in claim 1, wherein the cooling member includes a thermally conductive material.

6. The battery pack as claimed in claim 1, wherein:
the contact portions are at a first surface of the cooling member in positions corresponding to the terminals, and
a second surface of the cooling member opposite to the first surface is flat.

7. The battery pack as claimed in claim 6, wherein the cooling member is formed of a metal, an external surface of the metal being surrounded by an oxide layer at the contact portions.

8. The battery pack as claimed in claim 1, wherein:
the contact portions are at a first surface of the cooling member in positions corresponding to the terminals, and
a plurality of fluid channels are disposed at a second surface of the cooling member opposite to the first surface.

9. The battery pack as claimed in claim 8, wherein the fluid channels correspond to the contact portions.

10. The battery pack as claimed in claim 8, wherein the fluid channels have a surface exposed to an ambient atmosphere.

11. The battery pack as claimed in claim 8, wherein the cooling member is formed of a metal, an external surface of the metal being surrounded by an oxide layer at the contact portions.

12. The battery pack as claimed in claim 1, wherein the cooling member includes:
a case portion formed of a thermally conductive material, the case portion including a heat absorption portion; and
a plurality of contact portions on a surface of the case portion in positions corresponding to the terminals.

13. The battery pack as claimed in claim 12, wherein the heat absorption portion is hollow such that air flows through the heat absorption portion, the battery pack further comprising:
an inflow pipe, the inflow pipe being disposed at a first end of the heat absorption portion so as to allow the air from outside the heat absorption portion to flow through the heat absorption portion; and
an outflow pipe, the outflow pipe being disposed at a second end of the heat absorption portion so as to discharge the air of the heat absorption portion to the outside.

14. The battery pack as claimed in claim 12, wherein the heat absorption portion is filled with a heat-absorbing material that absorbs heat.

15. The battery pack as claimed in claim 14, wherein the heat-absorbing material includes silicone oil.

16. The battery pack as claimed in claim 14, wherein the heat-absorbing material includes a phase change material.

17. The battery pack as claimed in claim 12, wherein a cross-section of the contact portions farther from the terminals is larger than a cross-section of the contact portions nearer to the terminals.

18. The battery pack as claimed in claim 12, wherein at least a portion of an upper surface and a lateral surface of the contact portions is exposed to the heat absorption portion.

19. The battery pack as claimed in claim 12, wherein the case portion and the contact portions are formed as a single unit.

20. The battery pack as claimed in claim 19, wherein the case portion and the contact portions include a thermally conductive plastic.
